(19) United States
(12) Patent Application Publication
(10) Pub. No.: US 2026/0237279 A1
(43) Pub. Date: Aug. 13, 2026

(54) HAZARD DETECTOR CONTAINED WITHIN A FIXTURE SERVING AN UNRELATED PURPOSE

(71) Applicant: Microchip Technology Incorporated, Chandler, AZ (US)

(72) Inventors: Patrick McFarland, Gilbert, AZ (US); Arthur B. Eck, Gilbert, AZ (US)

(73) Assignee: Microchip Technology Incorporated, Chandler, AZ (US)

(21) Appl. No.: 19/171,634

(22) Filed: Apr. 7, 2025

Related U.S. Application Data
(60) Provisional application No. 63/757,533, filed on Feb. 12, 2025.

(51) Int. Cl. G08B 21/02; G08B 17/06; G08B 17/117

(52) U.S. Cl. CPC G08B 21/02; G08B 17/06; G08B 17/117

(57) ABSTRACT

An apparatus, system, and method for incorporating monitoring systems, e.g., smoke detectors, in pre-existing devices, e.g., a garage door opener, light switch, or electric outlet is disclosed. The apparatus may include an interface to a hazard detector. The hazard detector may have dimensions that fit substantially within a fixture installed in a wall or a ceiling of a building and attached to the fixture such that the hazard detector is contained substantially within the fixture, the fixture to serve a purpose unrelated to hazard detection. The apparatus may also include a control circuit. The control circuit may be configured to receive a signal from the hazard detector via the interface. The control circuit may also be configured to detect an unsafe condition based on the signal. The control circuit may further be to raise an alarm in response to the unsafe condition.

### PRIORITY

This application claims priority to U.S. Provisional Patent Application No. 63/757,533 filed February 12, 2025, the contents of which are hereby incorporated in their entirety.

### TECHNICAL FIELD

The present disclosure relates to monitoring systems and methods. Various examples of the teachings herein include systems and/or methods for incorporating hazard monitoring systems, e.g., smoke detectors, in pre-existing devices, e.g., a garage door opener, light switch, or electric outlet.

### BACKGROUND

Smart devices are becoming more pervasive in the modern home, taking up space on the walls and ceilings of the home. Additionally, monitors and sensors, e.g., carbon monoxide and smoke detectors, also take up space on the surface of a room’s wall or ceiling. The combination of smart devices, monitors, sensors, electric outlets, switches, and light fixtures contribute to cluttering up the interior of the modern home.

### SUMMARY OF THE INVENTION

Aspects provide systems and methods for incorporating hazard monitoring systems, e.g., smoke detectors, in pre-existing devices, e.g., a garage door opener, light switch, or electric outlet. Examples of the present disclosure may include an apparatus. The apparatus may include an interface to a hazard detector. The hazard detector may have dimensions that fit substantially within a fixture installed in a wall or a ceiling of a building and attached to the fixture such that the hazard detector is contained substantially within the fixture, the fixture to serve a purpose unrelated to hazard detection. The apparatus may also include a control circuit. The control circuit may be configured to receive a signal from the hazard detector via the interface. The control circuit may also be configured to detect an unsafe condition based on the signal. The control circuit may further be to raise an alarm in response to the unsafe condition.

In combination with any of the above examples, the fixture may be a utility box.

In combination with any of the above examples, the hazard detector may be at least one of a smoke detector, a carbon monoxide detector, a radon detector, an occupancy detector, or a temperature detector.

In combination with any of the above examples, the fixture may be a garage door opener. The control circuit may be configured to activate the garage door opener in response to the unsafe condition.

In combination with any of the above examples, the control circuit may be configured to activate a control to turn off a flow of a utility in response to the unsafe condition.

In combination with any of the above examples, the control circuit may be configured to activate a fan in response to the unsafe condition.

In combination with any of the above examples, the control circuit may be configured to activate a light in response to the unsafe condition.

Alone or in combination with any of the above examples, examples of the present disclosure may include a system. The system may include a fixture installed in a wall or a ceiling of a building. The fixture may be to serve a purpose unrelated to hazard detection. The system may also include a hazard detector having dimensions that fit substantially within the fixture and attached to the fixture such that the hazard detector is contained substantially within the fixture. The system may further include a control circuit communicatively coupled to the hazard detector. The control circuit may be configured to receive a signal from the hazard detector. The control circuit may also be to detect an unsafe condition based on the signal. The control circuit may further be to raise an alarm in response to the unsafe condition.

In combination with any of the above examples, the fixture may be a utility box.

In combination with any of the above examples, the hazard detector may be at least one of a smoke detector, a carbon monoxide detector, a radon detector, an occupancy detector, or a temperature detector.

In combination with any of the above examples, the fixture may be a garage door opener. The control circuit may be configured to activate the garage door opener in response to the unsafe condition.

In combination with any of the above examples, the control circuit may be configured to activate a control to turn off a flow of a utility in response to the unsafe condition.

In combination with any of the above examples, the control circuit may be configured to activate a fan in response to the unsafe condition.

In combination with any of the above examples, the control circuit may be configured to activate a light in response to the unsafe condition.

Alone or in combination with any of the above examples, examples of the present disclosure may include a method. The method may include receiving a signal from a hazard detector having dimensions that fit substantially within a fixture installed in a wall or a ceiling of a building and attached to the fixture such that the hazard detector is contained substantially within the fixture. The fixture may serve a purpose unrelated to hazard detection. The method may also include detecting an unsafe condition based on the signal. The method may further include raising an alarm in response to the unsafe condition.

In combination with any of the above examples, the fixture may be a utility box. The hazard detector may be at least one of a smoke detector, a carbon monoxide detector, a radon detector, an occupancy detector, or a temperature detector.

In combination with any of the above examples, the method may include activating a garage door opener in response to the unsafe condition.

In combination with any of the above examples, the method may include activating a control to turn off a flow of a utility in response to the unsafe condition.

In combination with any of the above examples, the method may include activating a fan in response to the unsafe condition.

In combination with any of the above examples, the method may include activating a light in response to the unsafe condition.

### BRIEF DESCRIPTION OF THE DRAWINGS

The figures illustrate examples of systems and methods for incorporating hazard monitoring systems, e.g., smoke detectors, in pre-existing devices, e.g., a garage door opener, light switch, or electric outlet.

FIGS. 1A and 1B illustrate a front view and a side view, respectively, of an example hazard detector of a hazard monitoring system incorporated into an electrical outlet, according to examples of the present disclosure;

FIG. 2 illustrates a front view of another example hazard detector of a hazard monitoring system incorporated into an electrical outlet, according to examples of the present disclosure;

FIG. 3 illustrates a front view of a further example hazard detector of a hazard monitoring system incorporated into an electrical outlet, according to examples of the present disclosure;

FIG. 4 illustrates a block diagram of a control circuit for a hazard monitoring system having a hazard detector incorporated into a fixture, according to examples of the present disclosure; and

FIG. 5 illustrates a method for using a hazard monitoring system having a hazard detector incorporated into a fixture, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, a system and method for incorporating hazard monitoring systems in pre-existing devices is provided. By installing monitoring systems (e.g., gas, temperature, smoke, and light sensors) in pre-existing devices (e.g., wall outlets, wall switches, ceiling fans, light fixtures, and garage door openers), the monitoring devices may provide additional functionality without taking up additional space on the walls or ceiling of the building and without requiring new or additional power wires. The invention may help in reducing installation costs, reducing clutter on the walls or ceilings of a building, improve the aesthetics in the building, and improve functionality of existing devices. Additionally, safety in the building may be increased because the monitoring devices are built-in and the user does not have to plug in the sensor, are less likely to be disabled, and may provide a response to detected environmental conditions.

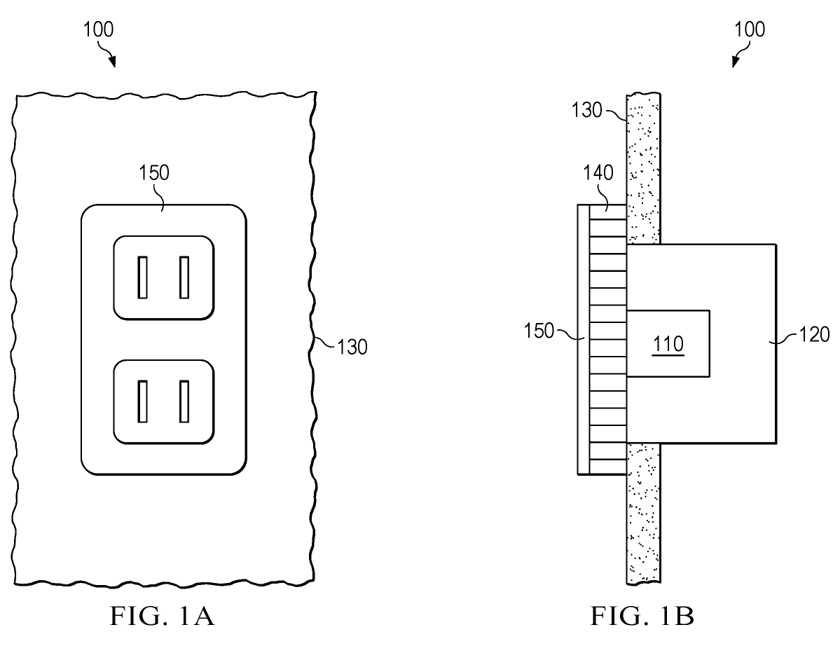

FIGS. 1A and 1B illustrate a front view and a side view, respectively, of an example hazard detector of a hazard monitoring system incorporated into an electrical outlet, according to examples of the present disclosure. Hazard monitoring system 100 may include hazard detector 110 incorporated into utility box 120 of an electrical outlet. Utility box 120 may be any suitable utility box, such as, but not limited to, a single gang, a double gang, or a triple gang utility box. Utility box 120 may have a primary purpose unrelated to hazard monitoring system 100 or hazard detector 110. For example, utility box 120 may be used to install utilities (e.g., outlets and switches) in buildings. Utility box 120 may be installed in wall 130 of a building. Utility box 120 may include internal components that allow utility box 120 to be used for its primary purpose. For example, utility box may include electrical outlets, switches, cables, or any combination thereof.

Hazard detector 110 may be co-located inside utility box 120 with the internal components of utility box 120 that allow utility box 120 to perform its primary purpose. Hazard detector 110 may be any suitable device for detecting an unsafe condition, such as, but not limited to, a smoke detector, a carbon monoxide detector, a carbon dioxide detector, a radon detector, any detector configured to detect the presence of a potentially hazardous gas (e.g., propane, methane, natural gas), a temperature detector, or an air quality detector (e.g., a detector to measure allergens, pollutants, or humidity). Hazard detector 110 may be powered by existing electrical wiring used to power the fixture. In some examples, hazard detector 110 may include backup power, such as a battery, to ensure that hazard detector 110 continues to operate in the event of a power outage.

Hazard monitoring system 100 may include vent 140 to allow the potentially hazardous material (e.g., smoke, gas) to enter hazard detector 110. For example, when hazard detector 110 is a smoke detector, vent 140 may allow smoke to enter a chamber of hazard detector 110. Vent 140 may be located between wall 130 and face plate 150 such that vent 140 is exposed to the environment in the building in which hazard monitoring system 100 is installed. In some examples, vent 140 may be a separate component fitting between wall 130 and face plate 150. In some examples, vent 140 may be integrated with face plate 150 to form a unitary component that is coupled to utility box 120.

Face plate 150 may be a conventional face plate used with utility box 120. While face plate 150 is shown in FIGS. 1A and 1B as having electrical outlets, face place 150 may be any suitable face plate for a utility box, such as including electrical outlets, switches, ports for internet cables (e.g., ethernet cables), ports for TV cables (e.g., coaxial cables), a blank plate, or any combination thereof.

Hazard detector 110 may be installed inside utility box 120 by removing face plate 150. In some examples, hazard detector 110 may be added to utility box 120 and fit inside utility box 120 with the existing internal components of utility box 120. In other examples, hazard detector 110 may be integrated with internal components of utility box 120 and form a unitary component installed in utility box 120. Once hazard detector 110 is installed in utility box 120, face plate 150 may be reinstalled on utility box 120 to complete the installation process. In examples where vent 140 is a component separate from face plate 150, vent 140 may be coupled to utility box 120 or face plate 150 prior to reinstalling face plate 150 on utility box 120.

In some examples, hazard monitoring system 100 may be interconnected with other monitoring systems in the building in which hazard monitoring system 100 is installed. For example, smoke or carbon monoxide detectors may be interconnected such that if smoke or carbon monoxide is detected by any detector in the building, all detectors will alert of the hazardous condition. Hazard monitoring system 100 may include an interconnection line to enable communication with other monitoring systems. Alternatively, or in addition to an interconnection line, hazard monitoring system 100 may communicate with other monitoring systems using powerline communication or wirelessly (e.g., using any suitable radio frequency communication protocol such as, but not limited to, Bluetooth, Wi-Fi, Zigbee, and Z-Wave. In some examples, hazard monitoring system 100 may communicate with a central hub that communicates with other monitoring systems.

While FIGS. 1A and 1B illustrate the integration of hazard detector 110 in utility box 120, hazard detector 110 may be integrated into other devices in a building, including, but not limited to, garage door openers, light fixtures, gas valves, ceiling fans, thermostats, or any combination thereof.

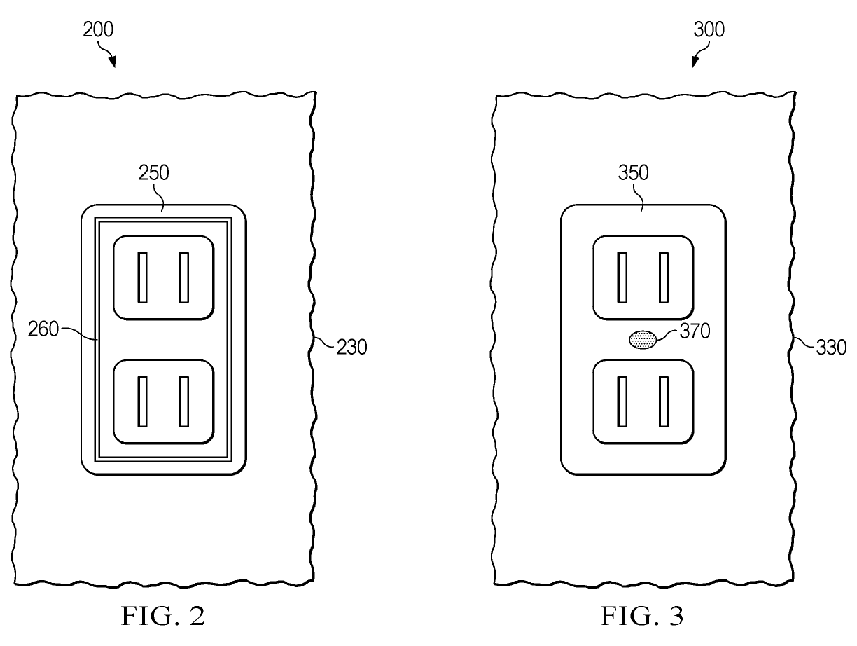

FIG. 2 illustrates a front view of another example hazard detector of a hazard monitoring system incorporated into an electrical outlet, according to examples of the present disclosure. Hazard monitoring system 200 may be similar to hazard monitoring system 100 shown in FIGS. 1A and 1B and may include a hazard detector (such as hazard detector 110 shown in FIG. 1B) incorporated into a utility box (such as utility box 120 shown in FIG. 1B) installed in wall 230. Hazard monitoring system 200 may include face plate 250 which may be similar to face plate 150 shown in FIGS. 1A and 1B.

Hazard monitoring system 200 may also include loop antenna 260 installed behind face plate 250. Loop antenna 260 may enable the hazard detector to communicate an alert. For example, loop antenna 260 may provide a connection between the hazard detector and an external speaker such that the external speaker sounds an audible alarm when the hazard detector identifies an unsafe condition. As another example, loop antenna 260 may provide a connection between the hazard detector and a light fixture to activate the light when the hazard detector identifies an unsafe condition. As a further example, loop antenna 260 may provide a connection between the hazard detector and a fan or vent to activate the fan or vent to increase ventilation in the building to mitigate the unsafe condition (e.g., expel smoke or hazardous gases). Loop antenna 260 may also enable the hazard detector to push notifications to a user’s smartphone.

FIG. 3 illustrates a front view of a further example hazard detector of a hazard monitoring system incorporated into an electrical outlet, according to examples of the present disclosure. Hazard monitoring system 300 may be similar to hazard monitoring system 100 shown in FIGS. 1A and 1B and may include a hazard detector (such as hazard detector 110 shown in FIG. 1B) incorporated into a utility box (such as utility box 120 shown in FIG. 1B) installed in wall 330. Hazard monitoring system 300 may include face plate 350 which may be similar to face plate 150 shown in FIGS. 1A and 1B.

Hazard monitoring system 300 may also include optical sensor 370. Optical sensor 370 may be incorporated into face plate 350. Optical sensor 370 may be used to detect light in the environment surrounding hazard monitoring system 300. Optical sensor 370 may be part of a hazard detector. For example, optical sensor 370 may be used as part of an optical beam smoke detector. Additionally, or alternatively, optical sensor 370 may be used as an occupancy detector. For example, optical sensor 370 may be used to determine if an occupant is present near hazard monitoring system 300 and, based on the presence of an occupant, hazard monitoring system 300 may raise alert if an unsafe condition is detected. In some examples, optical sensor 370 may be a sonic sensor or a combination of an optical or sonic sensor. Optical sensor 370 may communicate with other sensors, monitoring systems, or any combination thereof using an interconnection line. Alternatively, or in addition to an interconnection line, optical sensor 370 may communicate with other monitoring systems using powerline communication or wirelessly (e.g., using any suitable radio frequency communication protocol such as, but not limited to, Bluetooth, Wi-Fi, Zigbee, and Z-Wave. In some examples, optical sensor 370 may communicate with a central hub that communicates with other monitoring systems.

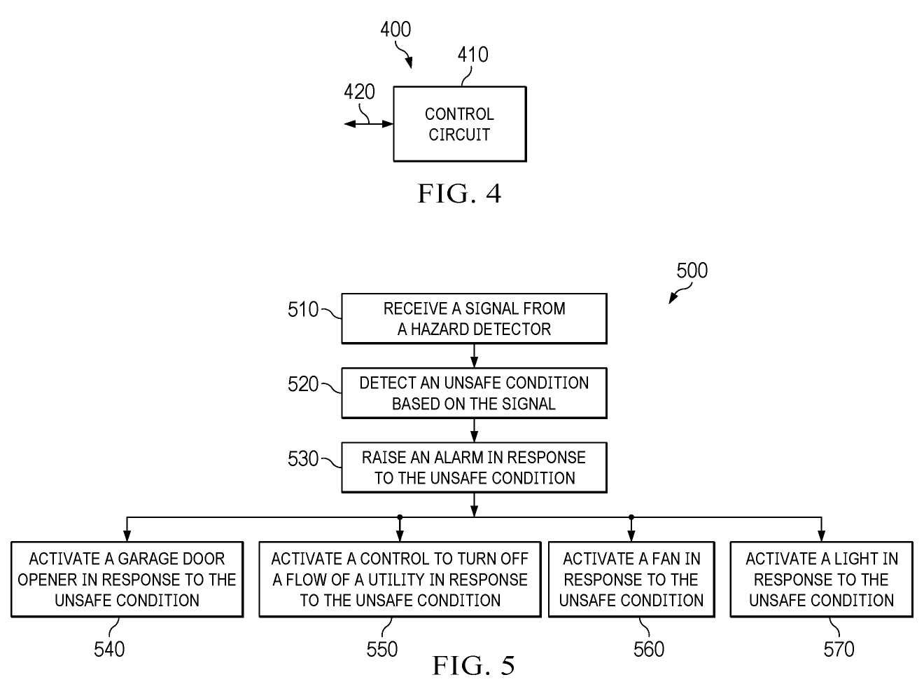

FIG. 4 illustrates a block diagram of a control circuit for a hazard monitoring system having a hazard detector incorporated into a fixture, according to examples of the present disclosure. System 400 may include control circuit 410 and hazard detector interface 420.

Control circuit 410 may be communicatively coupled to a hazard detector via hazard detector interface 420. The hazard detector may be similar to hazard detector 110 shown in FIG. 1B. The hazard detector may have dimensions such that the hazard detector fits substantially within a fixture (e.g., a utility box, a garage door opener, a light fixture, a ceiling fan, a thermostat, a switch) installed in a wall or ceiling of a building. The fixture in which the hazard detector is contained serves a purpose unrelated to hazard detection, such as providing an electrical outlet, housing a switch, providing light, providing ventilation, or opening a garage door.

Control circuit 410 may be implemented by instructions for execution by a processor, analog circuitry, digital circuitry, control logic, digital logic circuits programmed through hardware description language, application specific integrated circuits (ASIC), field programmable gate arrays (FPGA), programmable logic devices (PLD), or any suitable combination thereof, whether in a unitary device or spread over several devices. Control circuit 410 may be implemented by instructions for execution by a processor through, for example, a function, application programming interface (API) call, script, program, compiled code, interpreted code, binary, executable, executable file, firmware, object file, container, assembly code, or object. For example, control circuit 410 may be implemented by instructions stored in a non-transitory medium such as a memory that, when loaded and executed by a processor such as a central processing unit (CPU) (or any other suitable process), cause the functionality of control circuit 410 described herein.

Control circuit 410 may receive a signal from the hazard detector. Control circuit 410 may, based on the signal, detect an unsafe condition. If control circuit 410 detects an unsafe condition, control circuit 410 may raise an alarm to alert occupants of the building of the presence of the unsafe condition.

In some examples, control circuit 410 may take an action to mitigate the unsafe condition. For example, control circuit 410 may activate a garage door opener, activate a switch, activate a fan, or activate a light.

FIG. 5 illustrates a method for using a hazard monitoring system having a hazard detector incorporated into a fixture, according to examples of the present disclosure. Method 500 may be implemented by a hazard monitoring system, such as hazard monitoring system 100, 200, or 300 shown in FIGS. 1, 2, and 3, respectively. Although examples have been described above, other variations and examples may be made from this disclosure without departing from the spirit and scope of these disclosed examples.

Method 500 may begin at block 510 where the hazard monitoring system may receive a signal from a hazard detector. The hazard detector may have dimensions that fit substantially within a fixture installed in a wall or a ceiling of a building. The hazard detector may be attached to the fixture such that the hazard detector is contained substantially within the fixture. The fixture may serve a purpose unrelated to hazard detection, such as providing an electrical outlet, housing a switch, providing light, providing ventilation, or opening a garage door. For example, the hazard detector may be similar to hazard detector 110 shown in FIG. 1B and the fixture may be similar to utility box 120 shown in FIG. 1B.

At block 520, the hazard monitoring system may detect an unsafe condition based on the signal received at block 510. For example, where the hazard detector is a smoke detector, the unsafe condition may be the presence of smoke. Where the hazard detector is a carbon monoxide detector, the unsafe condition may be the presence of an unsafe level of carbon monoxide.

At block 530, the hazard monitoring system may raise an alarm in response to detecting an unsafe condition at block 520. The alarm may alert occupants of the building that, for example, smoke or an unsafe level of a gas has been detected.

At block 540, the hazard monitoring system may activate a garage door opener in response to detection of the unsafe condition. The activation of the garage door opener may mitigate the unsafe condition. For example, where a carbon monoxide detector is incorporated into a garage door opener, when the detector senses an abnormal amount of carbon monoxide, the detector may trigger the garage door opener to open the garage door. Opening the garage door may allow carbon monoxide to escape the garage and bring the amount of carbon monoxide present in the garage to a normal level.

At block 550, the hazard monitoring system may activate control to turn off a flow of a utility to the fixture in response to the unsafe condition. The control may be a switch, a valve, or any other mechanism that controls the flow of a utility (e.g., electricity, gas, propane, water) to a building. For example, the hazard monitoring system may, after detecting an abnormal amount of a gas, such as methane or propane, activate a switch to cut the flow of electricity to the home to prevent a spark. Additionally, the hazard detection system may activate other types of controls in response to the unsafe condition. For example, the hazard detection system may include a carbon monoxide detector into a switch or valve of a gas fireplace and, if carbon monoxide is detected, the detector may trigger the switch or valve to close the gas line. In other examples, the hazard monitoring system may activate a valve to turn off the flow of water to the building.

At block 560, the hazard monitoring system may activate a fan in response to the unsafe condition. For example, the hazard monitoring system may, after detecting smoke, turn on ceiling fans or other ventilation fans in the building to dissipate the smoke. As another example, the hazard monitoring system may, after detecting an abnormal amount of a gas, such as carbon monoxide, turn on ceiling fans or other ventilation fans in the building to bring the amount of carbon monoxide present in the building to a normal level.

At block 570, the hazard monitoring system may activate a light in response to the unsafe condition. For example, in addition to sounding an audible alarm, the hazard monitoring system may flash the lights in light fixture or a smart device. Flashing lights may be useful to alert hearing-impaired occupants of the building or the presence of an unsafe condition. As another example, the hazard monitoring system may illuminate lights to guide occupants out of the building after detecting an unsafe condition.

In some examples, blocks 540, 550, 560, and 570 may be performed in combination with one another to mitigate the unsafe condition.

Although FIG. 5 discloses a particular number of operations related to method 500, method 500 may be executed with greater or fewer operations than those depicted in FIG. 5. In addition, although FIG. 5 discloses a certain order of operations to be taken with respect to method 500, the operations comprising method 500 may be completed in any suitable order.

While the examples in the present disclosure illustrate hazard monitoring systems being incorporated into a utility box and face plate, monitoring devices may be incorporated into other fixtures, such as ceiling fans, garage door openers, light fixtures, thermostats, switches, and valves. The hazard detectors incorporated into existing building fixtures may provide additional functionality without taking up additional space on the walls or ceiling of the building and without requiring new or additional power wires.

Additionally, incorporation of a hazard monitoring system into an existing fixture may provide greater functionality. While a traditional hazard detector may be able to raise an audible alarm in response to detecting an unsafe condition, the hazard monitoring system described in the present disclosure may raise other types of alarms (e.g., visual alarms) and take subsequent action to mitigate the danger of the unsafe condition (e.g., activate fans, doors, switches, lights, water sprinklers or modify the settings of a heating, ventilation, and air conditioning (HVAC) system).

Further, incorporation of a hazard detector into existing fixtures may provide for more efficient detection of unsafe conditions. For example, carbon dioxide sensors may be more efficient at a low point on a wall and thus incorporating the sensor into a utility box used for an electrical outlet placed near the floor of a building may be beneficial. As another example, smoke sensors may be more efficient at a high point (e.g., on the ceiling) and thus incorporating the sensor into a light fixture or ceiling fan may be beneficial.

The disclosed hazard monitoring system may be used in a variety of applications. For example, in the hospitality industry, the disclosed hazard monitoring system may be integrated into hotel room fixtures like light switches, outlets, and ceiling fans to hotels to monitor for hazards like smoke or carbon monoxide without installing obvious standalone detectors that may detract from room aesthetics. The hazard monitoring system could alert hotel staff immediately if any issues are detected, improving guest safety. As another example, manufacturing plants, warehouses, and other industrial facilities may incorporate the disclosed hazard monitoring system into existing electrical infrastructure to provide comprehensive hazard monitoring throughout large spaces without requiring additional wiring or standalone units. The disclosed hazard monitoring system may integrate with industrial control systems to automatically shut down equipment or trigger ventilation if hazardous conditions are detected. As yet another example, schools, universities, and other educational facilities may use the disclosed hazard monitoring system in classrooms, dormitories, and common areas. By integrating the detectors into existing fixtures, schools may improve safety monitoring without disrupting learning environments. The disclosed hazard monitoring system may tie into centralized building management systems to quickly alert administrators of any issues. As a further example, hospitals, nursing homes, and other healthcare facilities may benefit from the disclosed hazard monitoring system in patient rooms and treatment areas. The disclosed hazard monitoring system could monitor for smoke, gases, or other hazards without adding visible equipment that may concern patients. Integration with nurse call systems may ensure rapid response to any detected issues. As another example, airports, train stations, and other transportation facilities may incorporate the disclosed hazard monitoring system into existing electrical fixtures throughout terminals, waiting areas, and other public spaces to allow for comprehensive safety monitoring of large, crowded areas without obvious standalone detectors. The disclosed hazard monitoring system may integrate with existing security and building management infrastructure. Additionally, by integrating the hazard monitoring system into existing fixtures, the difficulty for occupants (e.g., hotel guests, students, patients) to locate and disable a hazard detector may be increased, preventing occupants from engaging in unwanted behavior (e.g., smoking in a non-smoking area).

Although examples have been described above, other variations and examples may be made from this disclosure without departing from the spirit and scope of these disclosed examples.

1. An apparatus, comprising:
an interface to a hazard detector, wherein the hazard detector has dimensions that fit substantially within a fixture installed in a wall or a ceiling of a building and attached to the fixture such that the hazard detector is contained substantially within the fixture, the fixture to serve a purpose unrelated to hazard detection; and
a control circuit configured to:
receive a signal from the hazard detector via the interface;
detect an unsafe condition based on the signal; and
raise an alarm in response to the unsafe condition.

2. The apparatus of claim 1, wherein the fixture is a utility box.

3. The apparatus of claim 1, wherein the hazard detector is at least one of a smoke detector, a carbon monoxide detector, a radon detector, an occupancy detector, or a temperature detector.

4. The apparatus of claim 1, wherein:
the fixture is a garage door opener; and
the control circuit is configured to activate the garage door opener in response to the unsafe condition.

5. The apparatus of claim 1, wherein the control circuit is configured to activate a control to turn off a flow of a utility in response to the unsafe condition.

6. The apparatus of claim 1, wherein the control circuit is configured to activate a fan in response to the unsafe condition.

7. The apparatus of claim 1, wherein the control circuit is configured to activate a light in response to the unsafe condition.

8. A system, comprising:
a fixture installed in a wall or a ceiling of a building, the fixture to serve a purpose unrelated to hazard detection;
a hazard detector having dimensions that fit substantially within the fixture and attached to the fixture such that the hazard detector is contained substantially within the fixture; and
a control circuit communicatively coupled to the hazard detector and configured to:
receive a signal from the hazard detector;
detect an unsafe condition based on the signal; and
raise an alarm in response to the unsafe condition.

9. The system of claim 8, wherein the fixture is a utility box.

10. The system of claim 8, wherein the hazard detector is at least one of a smoke detector, a carbon monoxide detector, a radon detector, an occupancy detector, or a temperature detector.

11. The system of claim 8, wherein:
the fixture is a garage door opener; and
the control circuit is configured to activate the garage door opener in response to the unsafe condition.

12. The system of claim 8, wherein the control circuit is configured to activate a control to turn off a flow of a utility in response to the unsafe condition.

13. The system of claim 8, wherein the control circuit is configured to activate a fan in response to the unsafe condition.

14. The system of claim 8, wherein the control circuit is configured to activate a light in response to the unsafe condition.

15. A method, comprising:
receiving a signal from a hazard detector having dimensions that fit substantially within a fixture installed in a wall or a ceiling of a building and attached to the fixture such that the hazard detector is contained substantially within the fixture, the fixture to serve a purpose unrelated to hazard detection;
detecting an unsafe condition based on the signal; and
raising an alarm in response to the unsafe condition.

16. The method of claim 15, wherein the fixture is a utility box; and
the hazard detector is at least one of a smoke detector, a carbon monoxide detector, a radon detector, an occupancy detector, or a temperature detector.

17. The method of claim 15, comprising activating a garage door opener in response to the unsafe condition.

18. The method of claim 15, comprising activating a control to turn off a flow of a utility in response to the unsafe condition.

19. The method of claim 15, comprising activating a fan in response to the unsafe condition.

20. The method of claim 15, comprising activating a light in response to the unsafe condition.
